(19) United States
(12) Patent Application Publication
(10) Pub. No.: US 2026/0349319 A1
(43) Pub. Date: Nov. 5, 2026

(54) HANDHELD GIMBAL CAMERA AND DEVICE

(71) Applicant: Guilin Feiyu Technology Co., Ltd., Guilin (CN)

(72) Inventors: Chengyun Wei, Guilin (CN); Fazhan Chen, Xuzhou (CN); Yongqian Fan, Nanyang (CN); Liangliang Tan, Chenzhou (CN)

(21) Appl. No.: 19/731,214

(22) Filed: Jul. 6, 2026

(30) Foreign Application Priority Data
Aug. 15, 2025 (CN) 202521738681.1

(51) Int. Cl. G03B 17/56; H04N 23/51; H04N 23/62; H04N 23/65; H04N 23/68

(52) U.S. Cl. CPC G03B 17/563; G03B 17/561; H04N 23/51; H04N 23/62; H04N 23/65; H04N 23/687

(57) ABSTRACT

A handheld gimbal camera and device are provided. The handheld gimbal camera includes a handheld portion and a gimbal camera, where the gimbal camera is disposed on the handheld portion. The handheld portion includes a mounting portion and a display portion, the display portion is slidably connected to the mounting portion, and the display portion is slidable relative to the mounting portion. The display portion has at least two states relative to the handheld portion, the gimbal camera is exposed from the display portion in a first state, the gimbal camera is in a non-operating state in a second state, and the display portion locks the gimbal camera. The display portion slides relative to the handheld portion, such that the gimbal camera is stowed and locked.

### CROSS-REFERENCE TO RELATED APPLICATIONS

This application claims priority to Chinese Patent Application No. 202521738681.1, filed on Aug. 15, 2025, which is hereby incorporated by reference in its entirety.

### TECHNICAL FIELD

The present disclosure relates to the field of pet supplies, and in particular to a composite-structured pet mat.

### BACKGROUND

A handheld gimbal camera in the prior art includes a handheld portion and a gimbal camera, where the gimbal camera is connected to a top of the handheld portion. The gimbal camera includes a motor, and during operating of the gimbal camera, the motor is configured to compensate for jitter to achieve stabilized shooting by the gimbal camera. A display portion is disposed on the handheld portion, and the display portion is only available for viewing shooting contents, parameter configuration of the camera on a gimbal in an operating state. The handheld gimbal camera in the prior has the deficiencies as follows: the display portion fails to stow the gimbal, and fails to lock the gimbal in a non-operating state.

Therefore, a handheld gimbal camera or device is in need to solve the above problems.

### SUMMARY

To solve the above technical problems, the present disclosure employs the technical solutions as follows:

A handheld gimbal camera is provided, including a handheld portion and a gimbal camera, where the gimbal camera is disposed on the handheld portion. The handheld portion includes a mounting portion and a display portion, the display portion is slidably connected to the mounting portion, and the display portion is slidable relative to the mounting portion. The display portion has at least two states relative to the handheld portion, the gimbal camera is exposed from the display portion in a first state, the gimbal camera is in a non-operating state in a second state, and the display portion locks the gimbal camera.

In some implementations, during a transition from the first state to the second state, the display portion slides toward the gimbal camera relative to the handheld portion, and the display portion locks the gimbal camera in the second state; and during a transition from the second state to the first state, the display portion slides away from the gimbal camera relative to the handheld portion, and the display portion releases the gimbal camera in the first state.

In some implementations, the display portion includes an accommodating space, and in the first state, the accommodating space accommodates a portion of the handheld portion, enabling the display portion to be fixed to the handheld portion; and in the second state, the accommodating space accommodates a portion of the handheld portion and at least a portion of the gimbal camera.

In some implementations, the mounting portion includes first sliding portions, the display portion includes second sliding portions, and the first sliding portions are configured to engage with the second sliding portions, such that the display portion slides on the mounting portion.

In some implementations, the first sliding portions are arranged on opposite sides of the mounting portion, the second sliding portions are arranged on opposite sides of the display portion, and the first sliding portions on the opposite sides of the mounting portion are configured to engage with the second sliding portions on the opposite sides of the display portion, respectively.

In some implementations, the mounting portion is provided with first limiting members, the display portion is provided with second limiting members, the second limiting members are arranged at least two positions of the display portion, and the first limiting members are configured to engage with and be connected to the second limiting members at various positions.

In some implementations, when the display portion is in the first state, the first limiting members are configured to engage with the second limiting members at a first position to limit movement of the display portion relative to the handheld portion. When the display portion is in the second state, the first limiting members are configured to engage with the second limiting members at a second position to limit movement of the display portion relative to the handheld portion.

In some implementations, the mounting portion is provided with a power switch, a control circuit board is disposed within the handheld portion, and the power switch is electrically connected to the control circuit board.

In some implementations, the display portion further has a third state relative to the handheld portion, and the third state is located between the first state and the second state. When the display portion is in the third state, the first limiting members are configured to engage with the second limiting members at a third position, and the display portion simultaneously presses against the power switch.

In some implementations, first magnets are arranged on the mounting portion, second magnets are arranged on the display portion, the first magnets and the second magnets magnetically repel each other, and the display portion is driven in a sliding direction toward the first state or the second state by a repulsive force between the first magnets and the second magnets.

In some implementations, the first magnets are arranged on opposite sides of the mounting portion in the sliding direction, and the second magnets are arranged on opposite sides of the display portion in the sliding direction. In the first state, the first magnets on the opposite sides are simultaneously subjected to the repulsive force from the second magnets. In the second state, the first magnets on the opposite sides are simultaneously subjected to the repulsive force from the second magnets. A critical position is defined between the first state and the second state, and during sliding, after passing the critical position, the display portion is driven to automatically reach the first state or the second state by the repulsive force.

In some implementations, the mounting portion is provided with third sliding portions, and the display portion is provided with fourth sliding portions. The third sliding portions are arranged on opposite side surfaces of the handheld portion, the fourth sliding portions are arranged on opposite side surfaces of the display portion, and the third sliding portions are configured to engage with the fourth sliding portions.

In some implementations, end portions of the first sliding portions or the second sliding portions are provided with first stop members, and/or the third sliding portions or the fourth sliding portions are provided with second stop members.

In some implementations, when the display portion transitions from the first state to the third state, the gimbal camera is in the non-operating state, and the gimbal camera is in a stowed state in this case. During a transition from the second state to the third state, the gimbal camera in the non-operating state is powered on to activate a shooting function or a video recording function, or the gimbal camera remains in the non-operating state. During a transition from the third state to the first state, the gimbal camera remains powered on with the shooting function or the video recording function activated, or the gimbal camera remains in the non-operating state.

In some implementations, the mounting portion is provided with a through hole, the control circuit board is electrically connected to the display portion through a signal line, and the signal line penetrates through the through hole to be electrically connected to the display portion.

A handheld gimbal camera is provided, including a handheld portion and a gimbal camera, where the gimbal camera is disposed on the handheld portion. The handheld portion includes a display portion, and the gimbal camera is slidably connected to the display portion. The gimbal camera has at least two states relative to the display portion, the gimbal camera is exposed from the display portion in a first state, the gimbal camera is in a non-operating state in a second state, and the display portion locks the gimbal camera.

In some implementations, during a transition from the first state to the second state, the gimbal camera slides toward the display portion, and the display portion locks the gimbal camera in the second state. During a transition from the second state to the first state, the gimbal camera slides away from the display portion, and the display portion releases the gimbal camera in the first state.

In some implementations, the display portion includes an accommodating space. In the first state, the accommodating space is in an unoccupied state. In the second state, the accommodating space accommodates at least a portion of the gimbal camera and locks the gimbal camera.

In some implementations, a sliding portion is arranged on the accommodating space, the sliding portion is connected to the gimbal camera, and the sliding portion is configured to drive the gimbal camera to slide back and forth in the accommodating space.

A handheld gimbal device is provided, including the handheld gimbal camera in any one of the above implementations; and a control portion, configured to respond to trigger control during a transition from a first state to a second state, enabling a gimbal camera to be in a non-operating state.

In some implementations, a third state is further included, where the third state is between the first state and the second state. During a transition from the first state to the third state, the gimbal camera is in the non-operating state, and the gimbal camera is in a stowed state in this case. During a transition from the third state to the second state, the gimbal camera remains in the non-operating state. During a transition from the second state to the third state, the gimbal camera in the non-operating state is powered on to activate a shooting function or a video recording function, or the gimbal camera remains in the non-operating state. During a transition from the third state to the first state, the gimbal camera remains powered on with the shooting function or the video recording function activated, or the gimbal camera remains in the non-operating state.

In some implementations, a switch portion is further included, where the switch portion is electrically connected to the control portion. During a transition from the first state to the third state, the display portion or the gimbal camera presses against the switch portion to deactivate an operating state of the gimbal camera, and the gimbal camera enters the stowed state. And/or during a transition from the second state to the third state, the display portion or the gimbal camera presses against the switch portion to release the gimbal camera, such that the gimbal camera remains in the non-operating state, or the gimbal camera is powered on to activate the shooting function or the video recording function.

In some implementations, an interaction module is further included, where after the interaction module is triggered, the display portion transitions from the first state to the second state, and/or, the display portion transitions from the first state to the third state. And/or, the display portion transitions from the third state to the second state.

Or, after the interaction module is triggered, the gimbal camera transitions from the first state to the second state, and/or the gimbal camera transitions from the first state to the third state, and/or, the gimbal camera transitions from the third state to the second state.

In some implementations, after the interaction module is triggered, the display portion transitions from the second state to the first state, and/or the display portion transitions from the second state to the third state. And/or, the display portion transitions from the third state to the first state.

Or, after the interaction module is triggered, the gimbal camera transitions from the second state to the first state, and/or the gimbal camera transitions from the second state to the third state. And/or, the gimbal camera transitions from the third state to the first state.

In some implementations, the display portion includes a display surface, and the display surface may support touch control or button control.

In some implementations, display contents of the display surface are configured to indicate whether the gimbal camera is powered on, in the non-operating state, in a video recording mode or in a shooting mode in the first state, the second state or the third state.

Due to the adoption of the above technical solutions, the present disclosure achieves the following technical improvements over the prior art: 1. The gimbal camera is stowed and locked or released through sliding of the display portion relative to the handheld portion. Through such sliding of the display portion relative to the handheld portion, the gimbal camera is powered off or powered on, and the shooting function or the video recording function of the gimbal camera is activated.

2. The gimbal camera slides relative to the display portion, such that the gimbal camera is stowed into the display portion and locked by the display portion, or is released. Through such sliding of the gimbal camera relative to the display portion, the gimbal camera is powered off or powered on, and the shooting function or the video recording function of the gimbal camera is activated.

3. Travel interaction may be achieved during the sliding of the display portion relative to the handheld portion, or travel interaction may be achieved during the sliding of the gimbal camera relative to the display portion, including powering on/off the handheld gimbal camera, activating a sleep state, or activating the shooting function and the video recording function.

### BRIEF DESCRIPTION OF THE DRAWINGS

In order to more clearly describe the technical solutions in the embodiments of the present disclosure or in the prior art, a brief introduction to the accompanying drawings required for the description of the embodiments or the prior art will be provided below. Obviously, the accompanying drawings in the following description are merely some embodiments of the present disclosure. Those of ordinary skill in the art may also derive other accompanying drawings from these accompanying drawings without making inventive efforts.

FIGS. 1-7 are schematic structural views of a handheld gimbal camera when a display portion slides relative to a handheld portion of the present disclosure.

FIG. 8 is a schematic structural view of a display portion in a first state relative to a handheld portion of the present disclosure.

FIG. 9 is a schematic structural view of a display portion in a third state relative to a handheld portion of the present disclosure.

FIG. 10 is a schematic structural view of a display portion in a second state relative to a handheld portion of the present disclosure.

FIGS. 11 and 12 are schematic structural views of a handheld gimbal camera in a first state when a gimbal camera slides relative to a handheld portion of the present disclosure.

FIGS. 13 and 14 are schematic structural views of a handheld gimbal camera in a second state when a gimbal camera slides relative to a handheld portion of the present disclosure.

FIG. 15 is a schematic structural view of first magnets on a handheld portion of the present disclosure.

FIG. 16 is a sectional view from a side view of first magnets on a handheld portion of the present disclosure.

FIG. 17 is a schematic structural view of second magnets on a display portion of the present disclosure.

FIG. 18 is a sectional view from a side view of second magnets on a display portion of the present disclosure.

### DESCRIPTION OF EMBODIMENTS

In order to enable those skilled in the art to better understand the solution of the present disclosure, the technical solutions in the embodiments of the present disclosure will be clearly and completely described in conjunction with the accompanying drawings in the embodiments of the present disclosure.

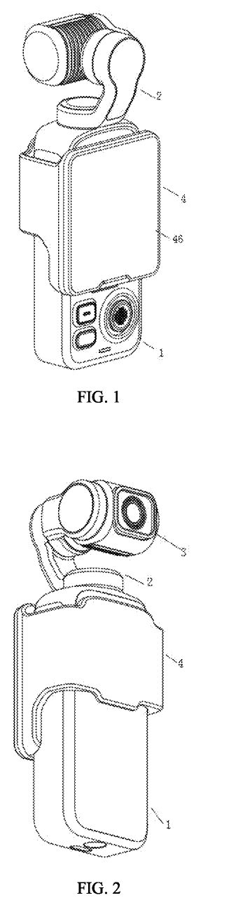

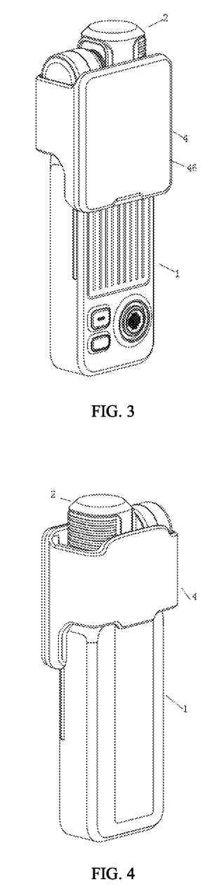

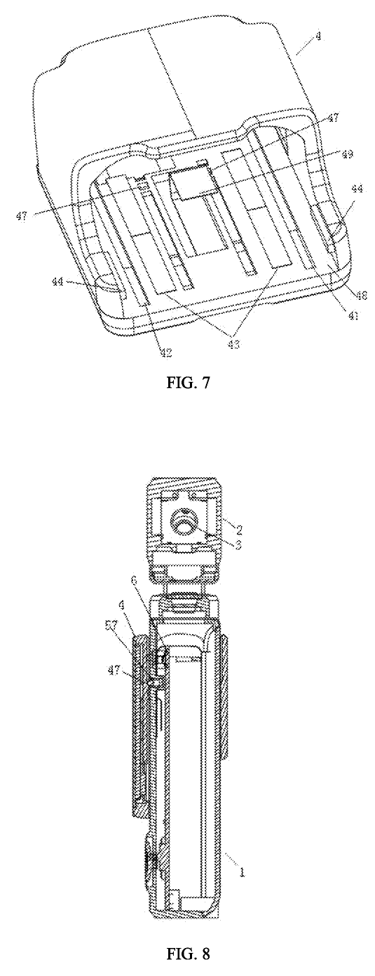

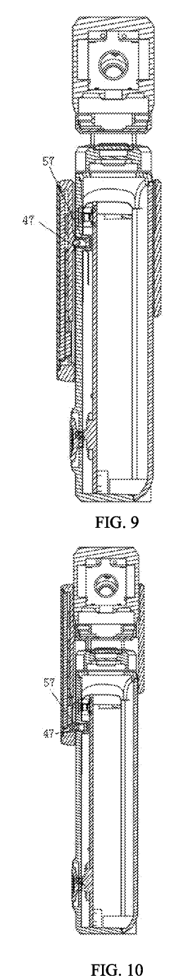

With reference to FIGS. 1-10 , the embodiment of the present disclosure provides a handheld gimbal camera, including a handheld portion 1 and a gimbal camera 2, where the gimbal camera 2 is disposed on the handheld portion 1. The handheld portion 1 includes a mounting portion 5 and a display portion 4, the display portion 4 is slidably connected to the mounting portion 5, and the display portion 4 is slidable relative to the mounting portion 5. The display portion 4 has at least two states relative to the handheld portion 1. In a first state, the gimbal camera 2 is exposed from the display portion 4, in a second state, the gimbal camera 2 is in a non-operating state, and the display portion 4 locks the gimbal camera 2.

The non-operating state of the present disclosure includes a power-off state or a sleep state.

Specifically, the display portion 4 has at least two states relative to the handheld portion 1, and the display portion 4 may also be referred to have at least two positional states relative to the handheld portion 1. The first state may be defined as a first positional state, and the second state as a second positional state.

When the display portion 4 locks the gimbal camera 2, the gimbal camera 2 fails to rotate freely. When the display portion 4 releases the gimbal camera 2, the gimbal camera 2 is allowed to rotate freely.

In some implementations, during a transition from the first state to the second state, the display portion 4 slides toward the gimbal camera 2 relative to the handheld portion 1, and the display portion 4 locks the gimbal camera 2 in the second state. During a transition from the second state to the first state, the display portion 4 slides away from the gimbal camera 2 relative to the handheld portion 1, and the display portion 4 releases the gimbal camera 2 in the first state.

Specifically, a transition from the first state to the second state may further be described as sliding from the first positional state to the second positional state. A transition from the second state to the first state may further be described as sliding from the second positional state to the first positional state.

In some implementations, the display portion 4 includes an accommodating space 48, and in the first state, the accommodating space 48 accommodates a portion of the handheld portion 1, enabling the display portion 4 to be fixed to the handheld portion 1. In the second state, the accommodating space 48 accommodates a portion of the handheld portion 1 and at least a portion of the gimbal camera 2, and locks the gimbal camera 2.

In some implementations, the mounting portion 5 of the handheld portion 1 includes first sliding portions 51, the display portion 4 includes second sliding portions 41, and the first sliding portions 51 are configured to engage with the second sliding portions 41, such that the display portion 4 slides on the mounting portion 5.

In some implementations, the first sliding portions 51, 52 are arranged on opposite sides of the mounting portion 5, the second sliding portions 41, 42 are arranged on opposite sides of the display portion 4, and the first sliding portions 51, 52 on the opposite sides of the mounting portion 5 are configured to engage with the second sliding portions 41, 42 on the opposite sides of the display portion 4, respectively. End portions of the first sliding portions 51, 52 and/or the second sliding portions 41, 42 are provided with first stop members to prevent the first sliding portions 51, 52 and the second sliding portions 41, 42 from disengaging with each other.

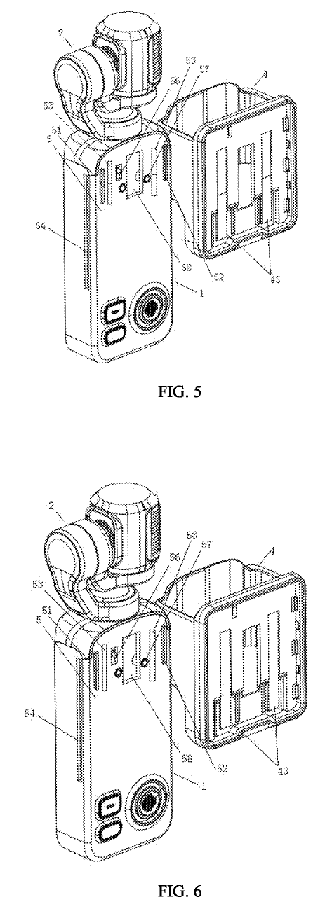

In some implementations, as shown in FIGS. 5 and 6 as well as 8-10 , the mounting portion 5 is provided with first limiting members 57, and the display portion 4 is provided with second limiting members 47. The second limiting members 47 are arranged at least two positions of the display portion 4, and the first limiting members 57 are configured to engage with and be connected to the second limiting members 47 at various positions.

In some implementations, when the display portion 4 is in the first state, the first limiting members 57 are configured to engage with the second limiting members 47 at a first position to limit movement of the display portion 4 relative to the handheld portion 1. When the display portion 4 is in the second state, the first limiting members 57 are configured to engage with the second limiting members 47 at a second position to limit movement of the display portion 4 relative to the handheld portion 1. In some implementations, each of the first limiting members 57 is an assembly formed by a lock pin and an elastic member, and each of the second limiting members 47 is a limiting groove. Or, each of the first limiting members 57 may be a groove, and each of the second limiting members 47 is an assembly formed by a lock pin and an elastic member. When each assembly is mounted on the mounting portion 5, one end of the elastic member is fixedly connected to the mounting portion 5, an end of the lock pin is connected to the other end of the elastic member, and the groove engages with the lock pin for limiting. When each assembly is disposed on the display portion 4, one end of the elastic member is fixedly connected to the display portion 4, an end of the lock pin is connected to the other end of the elastic member, and the groove is configured to engage with the lock pin for limiting. Each lock pin is configured to compress the corresponding elastic member under an action of pressure. When no pressure is applied, the elastic member releases an elastic force, enabling the lock pin to engage with the corresponding first limiting member or the corresponding second limiting member.

In some implementations, the mounting portion 5 is provided with a power switch 56, a control circuit board 6 is disposed within the handheld portion 1, and the power switch 56 is electrically connected to the control circuit board 6.

In some implementations, the display portion 4 further has a third state relative to the handheld portion 1, and the third state is located between the first state and the second state. When the display portion 4 is in the third state, the first limiting members 57 are configured to engage with the second limiting members 47 at a third position, and the display portion 4 presses against the power switch 56 simultaneously.

In some implementations, when the display portion 4 transitions from the first state to the third state relative to the handheld portion 1, the gimbal camera 2 is in the non-operating state, and the gimbal camera 2 is in a stowed state in this case. During a transition from the third state to the first state, the gimbal camera 2 in the non-operating state is powered on with a shooting function or a video recording function activated, or the gimbal camera 2 remains in the non-operating state. During a transition from the third state to the second state, the gimbal camera 2 in the non-operating state remains in the non-operating state, such that the display portion 4 accommodates the gimbal camera 2 and locks the gimbal camera 2 in the second state. During a transition from the second state to the third state, the gimbal camera 2 in the non-operating state is powered on with the shooting function or the video recording function activated, or the gimbal camera 2 remains in the non-operating state.

The third state is a state between the first state and the second state. When the display portion 4 transitions from the first state to the third state relative to the handheld portion 1, the gimbal camera 2 is in the non-operating state, and the gimbal camera 2 is in the stowed state in this case to prepare for locking of the gimbal camera 2, such that when the display portion 4 continues to slide upward, the display portion 4 locks the gimbal camera 2.

Specifically, the third state may be referred to as a third positional state. A transition from the first state to the third state may be described as sliding from the first positional state to the third positional state, a transition from the third state to the second state may be described as sliding from the third positional state to the second positional state, and vice versa.

The stowed state corresponds to an unfolded state. The stowed state refers to a state in which the gimbal camera 2 has a smaller size, while the unfolded state is a state in which the gimbal camera 2 has a larger size.

Specifically, the gimbal camera 2 may be a three-axis gimbal camera, a two-axis gimbal camera or a single-axis gimbal camera. The three-axis gimbal camera includes three motors, where a first motor is connected to a second motor via a first connecting arm, the second motor is connected to a third motor via a second connecting arm, and a third motor is connected to a camera 3. The first motor is connected to the handheld portion. When a gimbal is in a stowed state, the second motor drives the second connecting arm, the camera 3, the first connecting arm, and the third motor to move toward the first motor to reduce a size of the gimbal camera 2. The two-axis gimbal camera includes two motors, where a first motor is connected to the handheld portion, and the first motor is connected to a second motor through a first connecting arm. When the gimbal camera 2 is in the stowed state, a second connecting arm is configured to drive the second motor and a camera 3 to move close to the first motor to reduce the size of the gimbal camera 2. The single-axis gimbal camera includes a motor, the motor is connected to a camera via a connecting arm. When a gimbal is in a stowed state, the motor is configured to drive the connecting arm and the camera to move toward the handheld portion, thereby reducing the size of the gimbal camera 2.

When the gimbal camera 2 is in the unfolded state, for the three-axis gimbal camera, the second motor is configured to drive the first connecting arm and the second connecting arm, and the third motor is configured to drive the camera to move away from the first motor. For the two-axis gimbal camera, the first connecting arm is configured to drive the second motor, and the second motor is configured to drive the camera to be unfolded and move away from the first motor. For the single-axis gimbal camera, the connecting arm is configured to drive the camera to be unfolded and move away from the handheld portion.

In some implementations, during the sliding of the display portion 4 relative to the mounting portion 5, a display surface 46 is parallel to the handheld portion 1.

The first limiting members 57 are arranged on opposite sides of the mounting portion 5. The second limiting members 47 corresponding to each position are arranged on opposite sides of the display portion 4. That is, the second limiting members 47 at the first position are positioned on the opposite sides of the display portion 4, the second limiting members 47 at the second position are positioned on the opposite sides of the display portion 4, and the second limiting members 47 at the third position are positioned on the opposite sides of the display portion 4. The second limiting members 47 at each position on the opposite sides are configured to engage with the first limiting members 57 positioned on the opposite sides of the mounting portion 5, respectively.

In some implementations, the mounting portion 5 is provided with first magnets 53, the display portion 4 is provided with second magnets 43, and the first magnets 53 and the second magnets 43 magnetically repel each other. In the first state, the second magnets 43 of the display portion 4 receive a repulsive force from the first magnets 53 on the mounting portion 5 away from the gimbal camera 2. In this case, the second limiting members 47 at the first position of the display portion 4 are configured to engage with and be connected to the first limiting members 57 of the mounting portion 5, such that the display portion 4 is fixed to the mounting portion 5. During sliding from the first state to the second state, mutual magnetic repulsion between the second magnets 43 of the display portion 4 and the first magnets 53 of the mounting portion 5 pushes the display portion 4 to slide toward the gimbal camera 2 until the display portion 4 and the handheld portion 1 reach the second state. In the second state, the second limiting members 47 at the second position of the display portion 4 are configured to engage with and be connected to the first limiting members 57 of the mounting portion 5 to fix the display portion 4 on the mounting portion 5. In this case, the second magnets 43 of the display portion 4 are subjected to the repulsive force exerted by the first magnets 53 of the mounting portion 5. Through the repulsive force between the first magnets 53 and the second magnets 43, during sliding of the display portion 4, when a user enables the display portion 4 to slide to a certain position which may be referred to as a critical position, the display portion 4 automatically reaches the first state or the second state under the action of the repulsive force.

In some implementations, the first magnets 53 are arranged on opposite sides of the mounting portion 5, and the second magnets 43 are arranged on opposite sides of the display portion 4. In the first state, the display portion 4 is fixed at the first position of the mounting portion 5, and the second magnets 43 on the opposite sides are simultaneously subjected to the repulsive force from the first magnets 53. In the second state, the display portion 4 is fixed at the second position of the mounting portion 5, and the second magnets 43 on the opposite sides are simultaneously subjected to the repulsive force of the first magnets 53.

In some implementations, the first magnets 53 are arranged in a sliding direction of the mounting portion 5, and the second magnets 43 are arranged in a sliding direction of the display portion 4. Each of the first magnets 53 is an N-S magnet, and each of the second magnets 43 is an S-N magnet. Or, each of the first magnets 53 is an S-N magnet, and each of the second magnets 43 is an N-S magnet. As shown in FIG. 6, specifically, an end of each of the first magnets 53 close to the gimbal camera 2 is an N pole, and an end away from the gimbal camera 2 is an S pole. An end of each of the second magnets 43 close to the gimbal camera 2 is an S pole, and an end away from the gimbal camera 2 is an N pole. When the display portion 4 is fixed at the first position of the mounting portion 5, the display portion 4 is in the first state relative to the handheld portion 1, and the S pole of each of the first magnets 53 magnetically repels the S pole of the corresponding second magnet 43. When the display portion 4 is fixed at the second position of the mounting portion 5, the display portion 4 is in the second state relative to the handheld portion 1, and the N pole of each of the first magnets 53 magnetically repels the N pole of the corresponding second magnet 43. The first position is different from the second position. A certain position during a transition from the first position to the second position is defined as a critical position. After passing the critical position, the display portion 4 automatically reaches the second position under the action of the repulsive force generated between the first magnets 53 and the second magnets 43. During a transition from the second position back to the first position, after passing the critical position, the display portion 4 automatically reaches the first position under the action of the repulsive force generated between the first magnets 53 and the second magnets 43.

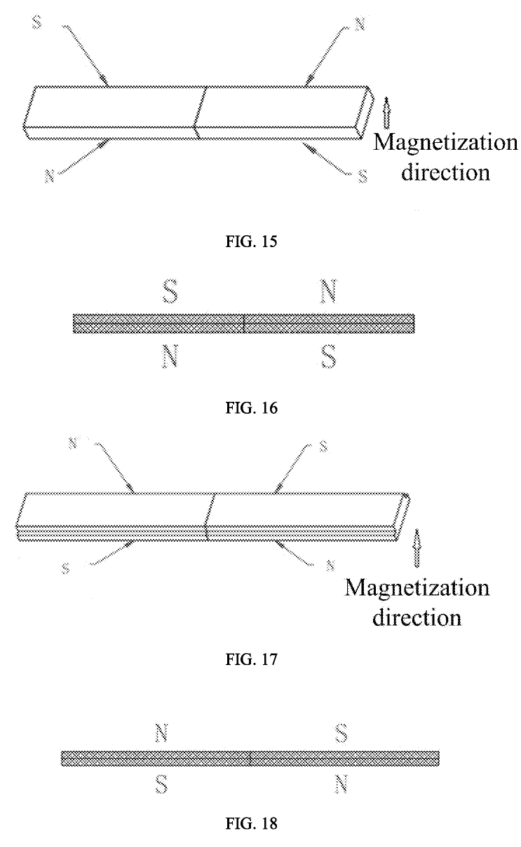

In some implementations, each of the first magnets 53 and each of the second magnets 43 are composite magnets, and opposing repulsion surfaces of each of the first magnets 53 and the corresponding second magnet 43 are high-strength magnetic surfaces. FIGS. 15-18 are the schematic structural views of the first magnets 53 arranged on the handheld portion 1 and the schematic structural views of the second magnets 43 arranged on the display portion 4. In some implementations, an end of an upper surface of each of the first magnets 53 away from the gimbal camera 2 is an N pole, and a lower surface corresponding to this end is an S pole. An end of the upper surface of each of the first magnets 53 close to the gimbal camera 2 is an S pole, and a lower surface corresponding to this end is an N pole. After magnetization, on the surface of each of the first magnets 53 facing the display portion 4, an end close to the gimbal camera 2 is an S pole, and an end away from the gimbal camera 2 is an N pole. An end of an upper surface of each of the second magnets 43 away from the gimbal camera 2 is an S pole, and a lower surface corresponding to this end is an N pole. An end of the upper surface of each of the second magnets 43 close to the gimbal camera 2 is an S pole, and a lower surface corresponding to this end is an N pole. After magnetization, on the surface of each of the second magnets 43 facing the mounting portion 5, the end close to the gimbal camera 2 is an N pole, and the end away from the gimbal camera 2 is an S pole. A magnetic field is applied to each magnet in a magnetic orientation direction to bring the magnet to a state of technical saturation, and this process is known as magnetization. After magnetization, the repulsive surfaces of each of the first magnets 53 and the corresponding second magnet 43 form a high-strength N-pole magnetic surface or a high-strength S-pole magnetic surface. When the display portion 4 is fixed at the first position of the mounting portion 5, the display portion 4 is in the first state relative to the handheld portion 1, and the high-strength N-pole magnetic surface of each of the first magnets 53 magnetically repels the high-strength N-pole magnetic surface of the corresponding second magnet 43. When the display portion 4 is fixed at the second position of the mounting portion 5, the display portion 4 is in the second state relative to the handheld portion 1, and the high-strength S-pole magnetic surface of each of the first magnets 53 magnetically repels the high-strength S-pole magnetic surface of the corresponding second magnet 43. The first position is different from the second position. A certain position during a transition from the first position to the second position is defined as a critical position. After passing the critical position, the display portion 4 automatically reaches the second position under the action of the repulsive force generated between the first magnets 53 and the second magnets 43. During a transition from the second position back to the first position, after passing the critical position, the display portion 4 automatically reaches the first position under the action of the repulsive force generated between the first magnets 53 and the second magnets 43.

The positions of the N pole and the S pole described in the present disclosure may be interchanged with each other, which is not limited herein.

In some implementations, the mounting portion 5 is provided with third sliding portions 54, and the display portion 4 is provided with fourth sliding portions 44. The third sliding portions 54 are arranged on opposite side surfaces of the handheld portion 1, the fourth sliding portions 44 are arranged on opposite side surfaces of the display portion 4, and the third sliding portions 54 are configured to engage with the fourth sliding portions 44.

In some implementations, second stop members are arranged on the third sliding portions 54 or the fourth sliding portions 44 to prevent the display portion 4 from disengaging from the handheld portion 1.

In some implementations, the mounting portion 5 is provided with a through hole 58, the control circuit board 6 is electrically connected to the display surface 46 through a signal line 49, and the signal line 49 penetrates through the through hole 58 to be electrically connected to the display surface 46. The signal line 49 is a flexible flat cable or a wire harness.

A handheld gimbal device is provided, including the handheld gimbal camera in any one of the above implementations; and a control portion, configured to respond to trigger control during a transition from a first state to a second state, enabling a gimbal camera 2 to be in a non-operating state.

In an implementation, a third state is further included, and where the third state is between the first state and the second state. During a transition from the first state to the third state, the gimbal camera 2 is in the non-operating state, and the gimbal camera 2 is in a stowed state in this case. During a transition from the third state to the second state, the gimbal camera 2 remains in the non-operating state and the stowed state. During a transition from the second state to the third state, the gimbal camera 2 is powered on to activate a shooting function or a video recording function, or the gimbal camera 2 remains in the non-operating state. During a transition from the third state to the first state, the gimbal camera 2 remains powered on with the shooting function or the video recording function activated, or the gimbal camera remains 2 in the non-operating state.

In some implementations, a switch portion is further included, and the switch portion is electrically connected to the control portion. During a transition from the first state to the third state, the display portion 4 presses against the switch portion to deactivate an operating state of the gimbal camera 2, and the gimbal camera 2 enters the stowed state. And/or, during a transition from the second state to the third state, the display portion 4 presses against the switch portion to release the gimbal camera 2, such that the gimbal camera 2 remains in the non-operating state, or the gimbal camera 2 is powered on to activate the shooting function or the video recording function.

In some implementations, the switch portion is a power switch 56.

In some implementations, an interaction module is further included. After the interaction module is triggered, the display portion 4 transitions from the first state to the second state, and/or the display portion 4 transitions from the first state to the third state, and/or the display portion 4 transitions from the third state to the second state.

In some implementations, after the interaction module is triggered, the display portion 4 transitions from the second state to the first state, and/or the display portion 4 transitions from the second state to the third state, and/or the display portion 4 transitions from the third state to the first state.

In some implementations, the display portion 4 includes a display surface 46, and the display surface 46 may support touch control or button control.

In some implementations, display contents of display surface 46 are configured to indicate whether the gimbal camera 2 is powered on, in the non-operating state, in a video recording mode or in a shooting mode in the first state, the second state or the third state.

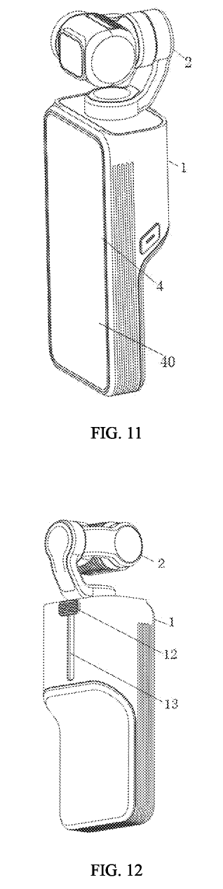

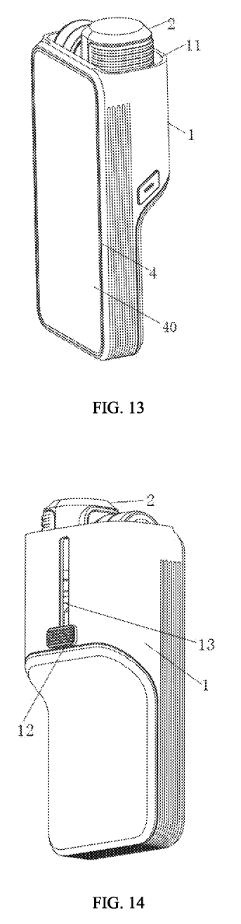

With reference to FIGS. 11-14 , a handheld gimbal camera is provided, including a handheld portion 1 and a gimbal camera 2, where the gimbal camera 2 is disposed on the handheld portion 1. The handheld portion 1 includes a display portion 4, and the gimbal camera 2 is slidably connected to the display portion 4. The gimbal camera 2 has at least two states relative to the display portion 4. In a first state, the gimbal camera 2 is exposed from the display portion 4, in a second state, the gimbal camera 2 is in a non-operating state, and the display portion 4 locks the gimbal camera 2.

The non-operating state of the present disclosure includes a power-off state and a sleep state.

When the display portion 4 locks the gimbal camera 2, the gimbal camera 2 fails to rotate freely. When the display portion 4 releases the gimbal camera 2, the gimbal camera 2 is allowed to rotate freely.

Specifically, the first state may be referred to as a first positional state, and the second state may be referred to as a second positional state.

In some implementations, during a transition from the first state to the second state, the gimbal camera 2 slides toward the display portion 4, and the display portion 4 locks the gimbal camera 2 in the second state. During a transition from the second state to the first state, the gimbal camera 2 slides away from the display portion 4, and the display portion 4 releases the gimbal camera 2 in the first state.

Specifically, a transition from the first state to the second state may be described as sliding from the first positional state to the second positional state, and a transition from the second state to the first state may be described as sliding from the second positional state to the first positional state.

In some implementations, the display portion 4 includes an accommodating space 11, and in the first state, the accommodating space 11 is in an unoccupied state. In the second state, the accommodating space 11 accommodates at least a portion of the gimbal camera 2 and locks the gimbal camera 2.

In the first state, the statement that the accommodating space 11 is in an unoccupied state means that the accommodating space is provided with a hollow space capable of accommodating the gimbal camera 2, such that the gimbal camera 2 is accommodated in the accommodating space 11 when sliding toward the display portion 4.

In some implementations, a sliding portion is arranged on the accommodating space 11, the sliding portion is connected to the gimbal camera 2, and the sliding portion is configured to drive the gimbal camera 2 to slide back and forth in the accommodating space 11. Specifically, the sliding portion may be a sliding rod 12.

A sliding groove 13 is formed on a housing of the accommodating space 11, one end of the sliding rod 12 is arranged on the sliding groove 13, and the other end thereof is connected to the gimbal camera 2. The portion of the sliding rod 12 located on the sliding groove 13 is enabled to slide along the sliding groove 13 to drive the gimbal camera 2 to slide into the accommodating space 11.

A handheld gimbal device is provided, including the handheld gimbal camera in any one of the above implementations; and a control portion, configured to respond to trigger control during a transition from a first state to a second state, enabling a gimbal camera 2 to be in a non-operating state.

In some implementations, a third state is further included, where the third state is between the first state and the second state. During a transition from the first state to the third state, the gimbal camera 2 is in the non-operating state, and the gimbal camera 2 is in a stowed state in this case. During a transition from the third state to the second state, the gimbal camera 2 remains in the non-operating state and the stowed state. During a transition from the second state to the third state, the gimbal camera 2 is powered on to activate a shooting function or a video recording function, or the gimbal camera 2 remains in the non-operating state. During a transition from the third state to the first state, the gimbal camera 2 remains powered on with the shooting function or the video recording function activated, or the gimbal camera 2 remains in the non-operating state.

Specifically, the third state may be referred to as a third positional state. A transition from the first state to the third state may be described as sliding from the first positional state to the third positional state, a transition from the second state to the third state may be described as sliding from the second positional state to the third positional state, and vice versa

In some implementations, a switch portion is further included, and the switch portion is electrically connected to the control portion. During a transition from the first state to the third state, the gimbal camera 2 presses against the switch portion to deactivate an operating state of the gimbal camera 2, and the gimbal camera 2 enters the stowed state. And/or, during a transition from the second state to the third state, the gimbal camera 2 presses against the switch portion to release the gimbal camera 2, such that the gimbal camera 2 remains in the non-operating state, or the gimbal camera 2 is powered on to activate the shooting function or the video recording function.

In some implementations, an interaction module is further included. After the interaction module is triggered, the gimbal camera 2 transitions from the first state to the second state, and/or the gimbal camera 2 transitions from the first state to the third state, and/or the gimbal camera 2 transitions from the third state to the second state.

In some implementations, after the interaction module is triggered, the gimbal camera 2 transitions from the second state to the first state, and/or the gimbal camera 2 transitions from the second state to the third state, and/or the gimbal camera 2 transitions from the third state to the first state.

In some implementations, the display portion 4 includes a display surface 40, and the display surface 40 may support touch control or button control.

In some implementations, display contents of the display surface 40 of the display portion 4 are configured to indicate whether the gimbal camera 2 is powered on, in the non-operating state, in a video recording mode or in a shooting mode in the first state, the second state or the third state.

Although the present disclosure has been generally described in detail above, some modifications or improvements may be made on the basis of the present disclosure, which is apparent to those of ordinary skill in the art. Therefore, the modifications or the improvements made without departing from the spirit and concept of the present disclosure should fall within the protection scope of the present disclosure.

What is claimed is:

1. A handheld gimbal camera, comprising a handheld portion and a gimbal camera, wherein the gimbal camera is disposed on the handheld portion; the handheld portion comprises a mounting portion and a display portion, the display portion is slidably connected to the mounting portion, the display portion is slidable relative to the mounting portion, and the display portion has at least two states relative to the handheld portion; and the gimbal camera is exposed from the display portion in a first state, the gimbal camera is in a non-operating state in a second state, and the display portion locks the gimbal camera.

2. The handheld gimbal camera according to claim 1, wherein during a transition from the first state to the second state, the display portion slides toward the gimbal camera relative to the handheld portion, and the display portion locks the gimbal camera in the second state; and during a transition from the second state to the first state, the display portion slides away from the gimbal camera relative to the handheld portion, and the display portion releases the gimbal camera in the first state.

3. The handheld gimbal camera according to claim 2, wherein the display portion comprises an accommodating space; in the first state, the accommodating space accommodates a portion of the handheld portion, enabling the display portion to be fixed to the handheld portion; and in the second state, the accommodating space accommodates a portion of the handheld portion and at least a portion of the gimbal camera;
the mounting portion comprises first sliding portions, the display portion comprises second sliding portions, and the first sliding portions are configured to engage with the second sliding portions, such that the display portion slides on the mounting portion;
the first sliding portions are arranged on opposite sides of the mounting portion, the second sliding portions are arranged on opposite sides of the display portion, and the first sliding portions on the opposite sides of the mounting portion are configured to engage with the second sliding portions on the opposite sides of the display portion, respectively;
the mounting portion is provided with first limiting members, the display portion is provided with second limiting members, and the second limiting members are arranged at least two positions of the display portion; and the second limiting members comprise second limiting members at a first position and second limiting members at a second position, and the first limiting members are configured to engage with and be connected to the second limiting members at the first position or the second limiting members at the second position.

4. The handheld gimbal camera according to claim 3, wherein when the display portion is in the first state, the first limiting members are configured to engage with the second limiting members at the first position to limit movement of the display portion relative to the handheld portion; and when the display portion is in the second state, the first limiting members are configured to engage with the second limiting members at the second position to limit movement of the display portion relative to the handheld portion.

5. The handheld gimbal camera according to claim 4, wherein the mounting portion is provided with a power switch, a control circuit board is disposed within the handheld portion, and the power switch is electrically connected to the control circuit board.

6. The handheld gimbal camera according to claim 5, wherein the display portion further has a third state relative to the handheld portion; the third state is located between the first state and the second state; and when the display portion is in the third state, the second limiting members comprise second limiting members at a third position, the first limiting members are configured to engage with the second limiting members at the third position, and the display portion simultaneously presses against the power switch.

7. The handheld gimbal camera according to claim 6, wherein first magnets are arranged on the mounting portion, and second magnets are arranged on the display portion; the first magnets and the second magnets magnetically repel each other, and the display portion is driven in a sliding direction toward the first state or the second state by a repulsive force between the first magnets and the second magnets;
the first magnets are arranged on opposite sides of the mounting portion in the sliding direction, and the second magnets are arranged on opposite sides of the display portion in the sliding direction; in the first state, the first magnets on the opposite sides are simultaneously subjected to the repulsive force from the second magnets; in the second state, the first magnets on the opposite sides are simultaneously subjected to the repulsive force from the second magnets; and a critical position is defined between the first state and the second state, and during sliding, after passing the critical position, the display portion is driven to automatically reach the first state or the second state by the repulsive force.

8. The handheld gimbal camera according to claim 7, wherein the mounting portion is provided with third sliding portions, and the display portion is provided with fourth sliding portions; and the third sliding portions are arranged on opposite side surfaces of the handheld portion, the fourth sliding portions are arranged on opposite side surfaces of the display portion, and the third sliding portions are configured to engage with the fourth sliding portions.

9. The handheld gimbal camera according to claim 8, wherein end portions of the first sliding portions or the second sliding portions are provided with first stop members, and/or the third sliding portions or the fourth sliding portions are provided with second stop members.

10. The handheld gimbal camera according to claim 9, wherein when the display portion transitions the first state to the third state, the gimbal camera is in the non-operating state, and is in a stowed state; when the display portion transitions from the second state to the third state, the gimbal camera in the non-operating state is powered on to activate a shooting function or a video recording function, or the gimbal camera remains in the non-operating state; and when the display portion transitions the third state to the first state, the gimbal camera remains powered on with the shooting function or the video recording function activated, or the gimbal camera remains in the non-operating state.

11. The handheld gimbal camera according to claim 10, wherein the mounting portion is provided with a through hole, the control circuit board is electrically connected to the display portion through a signal line, and the signal line penetrates through the through hole to be electrically connected to the display portion.

12. A handheld gimbal camera, comprising a handheld portion and a gimbal camera, wherein the gimbal camera is disposed on the handheld portion; the handheld portion comprises a display portion, the gimbal camera is slidably connected to the display portion, and the gimbal camera has at least two states relative to the display portion; and the gimbal camera is exposed from the display portion in a first state, the gimbal camera is in a non-operating state in a second state, and the display portion locks the gimbal camera.

13. The handheld gimbal camera according to claim 12, wherein during a transition from the first state to the second state, the gimbal camera slides toward the display portion, and the display portion locks the gimbal camera in the second state; and during a transition from the second state to the first state, the gimbal camera slides away from the display portion, and the display portion releases the gimbal camera in the first state.

14. The handheld gimbal camera according to claim 13, wherein the display portion comprises an accommodating space; in the first state, the accommodating space is in an unoccupied state; and in the second state, the accommodating space accommodates at least a portion of the gimbal camera and locks the gimbal camera; and
a sliding portion is arranged on the accommodating space, the sliding portion is connected to the gimbal camera, and the sliding portion is configured to drive the gimbal camera to slide back and forth in the accommodating space.

15. A handheld gimbal device, comprising the handheld gimbal camera according to claim 1, and
a control portion, configured to respond to trigger control during a transition from a first state to a second state, enabling the gimbal camera to be in a non-operating state.

16. The handheld gimbal device according to claim 15, further comprising a third state, wherein the third state is between the first state and the second state; during a transition from the first state to the third state, the gimbal camera is in the non-operating state, and is in a stowed state; during a transition from the third state to the second state, the gimbal camera remains in the non-operating state; during a transition from the second state to the third state, the gimbal camera in the non-operating state is powered on to activate a shooting function or a video recording function, or the gimbal camera remains in the non-operating state; and during a transition from the third state to the first state, the gimbal camera remains powered on with the shooting function or the video recording function activated, or the gimbal camera remains in the non-operating state.

17. The handheld gimbal device according to claim 16, further comprising a switch portion, wherein the switch portion is electrically connected to the control portion; during a transition from the first state to the third state, the display portion or the gimbal camera presses against the switch portion to deactivate an operating state of the gimbal camera, and the gimbal camera is in the stowed state; and/or during a transition from the second state to the third state, the display portion or the gimbal camera presses against the switch portion to release the gimbal camera, such that the gimbal camera remains in the non-operating state, or the gimbal camera is powered on to activate the shooting function or the video recording function.

18. The handheld gimbal device according to claim 17, further comprising an interaction module, wherein after the interaction module is triggered, the display portion transitions from the first state to the second state, or the display portion transitions from the first state to the third state and then to the second state; or the display portion transitions from the second state to the first state, or the display portion transitions from the second state to the third state and then to the first state.

19. The handheld gimbal device according to claim 18, wherein after the interaction module is triggered, the gimbal camera transitions from the first state to the second state, or the gimbal camera transitions from the first state to the third state and then to the second state; or the gimbal camera transitions from the second state to the first state, or the gimbal camera transitions from the second state to the third state and then to the first state.

20. The handheld gimbal device according to claim 19, wherein the display portion comprises a display surface, and the display surface supports touch control or button control; and
display contents of the display surface are configured to indicate whether the gimbal camera is powered on, in the non-operating state, in a video recording mode or in a shooting mode in the first state, the second state or the third state.
